(19) United States
(12) Patent Application Publication
(10) Pub. No.: US 2016/0117711 A1
(43) Pub. Date: Apr. 28, 2016

(54) Method for Directly Issuing and Using Discount Coupon for Product Bought by Consumer Himself/Herself

(71) Applicant: Young Hyun SEO, Daegu (KR)

(72) Inventor: Young Hyun Seo, Daegu (KR)

(21) Appl. No.: 14/894,163

(22) PCT Filed: May 26, 2014
(86) PCT No.: PCT/KR2014/004663

§ 371 Date: Nov. 25, 2015

(30) Foreign Application Priority Data
May 27, 2013 (KR) 10-2013-0059416

(51) Int. Cl. G06Q 30/02

(52) U.S. Cl. CPC G06Q 30/0221; G06Q 30/0235

(57) ABSTRACT

The present invention relates to a method for directly issuing and using, by a consumer himself/herself, a discount coupon for a product, which the consumer has bought, in a discount coupon service used by consumers buying a product, or a system therefor. More particularly, the present invention relates to “a method for directly issuing and using, by a consumer himself/herself, a discount coupon for a product bought by the consumer,” in which not only can the consumer acquire and use a right to issue a predetermined discount coupon according to a product purchase history, but the consumer can also transfer and sell the discount coupon issued by the consumer himself/herself, to another person, so that the consumer can get more benefits.

### TECHNICAL FIELD

The present invention relates to a method for directly issuing and using, by a consumer himself/herself, a discount coupon for a product, which the consumer has purchased, in a discount coupon service used by consumers purchasing a product, or a system therefor, and more particularly, to “a method for directly issuing and using, by a consumer himself/herself, a discount coupon for a product purchased by the consumer”, in which the consumer can not only acquire and use a right to issue a predetermined discount coupon according to product purchase records but also transfer and sell the discount coupon issued by the consumer himself/herself, to another person, so that the consumer can get more benefits.

### BACKGROUND ART

Generally, when a consumer purchases a product from an offline or online shopping mall, the consumer may use his/her discount coupons.

Such discount coupons are provided by a product seller, and have been conventionally distributed in the form of a discount coupon brochure or leaflet.

Recently, with the advancement of IT devices such as smart phones or the like and the advent of social commerce as a new form of commerce, methods for providing and using discount coupons have become more diverse.

However, the conventional discount coupon has the following problems.

1. Only a seller can issue a discount coupon.

2. A discount coupon has a term of validity, and the discount coupon cannot be used after the term of validity expires.

3. Even if a discount coupon acquired by a consumer A when purchasing a product is used by a consumer B, the consumer A cannot get any benefit.

4. If a consumer repeatedly purchases a predetermined product, the consumer may receive benefits such as points or the like, but a discount coupon for the purchased product is not reissued or any additional benefit is not given.

### DISCLOSURE

### Technical Problem

Accordingly, the present invention is suggested to solve the above-described problems of the conventional discount coupon, and directed to enabling the following.

1. A consumer can directly issue a discount coupon.

2, A term of validity of the discount coupon can be extended according to a repurchase result.

3. If a discount coupon acquired by a consumer A when purchasing a product is used by a consumer B, the discount coupon is regarded as being used by the consumer A, so that the consumer A can get benefits in various ways according to regulations in the agreement.

4. If a consumer repeatedly purchases a predetermined product, a discount coupon for the corresponding purchased product can be repeatedly issued and additional benefit can be given.

5. A consumer A can allow a third person to use a discount coupon directly issued by the consumer A himself/herself or can also transfer (or sell) the discount coupon.

### Technical Solution

One aspect of the present invention provides a method for directly issuing a predetermined discount coupon for each purchased product by a member himself/herself when the member purchases a product from an offline shop or online shopping mall with a system including a terminal into which a product purchase status is input and a product sales management server interworking with the terminal through a wired/wireless network so as to be used for further purchase of a product.

The present invention includes the following steps:

(a) transmitting purchase information of at least one product purchased by the member to the product sales management server through the terminal;

(b) generating at least one right to issue a discount coupon having a predetermined discount rate for each product purchased by the member and storing the right in the product sales management server;

(c) directly issuing a discount coupon having a predetermined discount rate by the member himself/herself using the at least one right to issue a discount coupon stored in the product sales management server; and

(d) wirelessly transmitting the issued discount coupon to a portable terminal of the member.

Further, in the present invention, a term of validity is individually set for each of the at least one right to issue a discount coupon stored in the product sales management server.

Furthermore, in the present invention, if the discount coupon issued by exercising at least any one of the at least one right to issue a discount coupon within a term of validity is transmitted to the portable terminal and then, the discount coupon is used at the time of payment for repurchase of a product through the terminal, the term of validity of at least one non-exercised right to issue a discount coupon is additionally extended by a predetermined time period.

In the present invention, the discount coupon includes information of the member who issues the discount coupon and information of a product for which the discount coupon can be used.

Further, the present invention may further include: using the discount coupon, which is wirelessly transmitted to the portable terminal of the member and then retransmitted to a portable terminal of a third member, by the third member.

In the present invention, if the third member purchases a predetermined product using the discount coupon, the term of validity of at least one non-exercised right of the member to issue a discount coupon is additionally extended by a predetermined time period with reference to the information of the member included in the discount coupon.

Another aspect of the present invention provides a method for directly issuing a predetermined discount coupon for each purchased product by a member himself/herself when the member purchases products from an offline shop or online shopping mall with a system including a terminal into which a product purchase status is input and a product sales management server interworking with the terminal through a wired/wireless network so as to be used for further purchase of a product, the method including:

(a) transmitting purchase information of a first product purchased by the member to the product sales management server through the terminal;

(b) generating at least a first right to issue a discount coupon having a predetermined discount rate for the first product purchased by the member and storing the right in the product sales management server;

(c) directly issuing a first discount coupon having a predetermined discount rate by the member himself/herself using the first right to issue a discount coupon stored in the product sales management server; and

(d) wirelessly transmitting the first discount coupon to a portable terminal of the member,

wherein the discount coupon includes information of the member and information of kinds of products for which the discount coupon can be used,

when the member further purchases the same product as the first product after the purchase of the first product, the first discount coupon transmitted to the portable terminal can be used, and

when the member further purchases a second product different from the first product after the purchase of the first product, if the second product is included in the information of kinds of products for which the discount coupon can be used, the first discount coupon can be used.

### Advantageous Effects

A method for issuing a discount coupon according to the present invention has the following advantages.

Firstly, since a consumer receives a right to issue a discount coupon for each product purchased by the consumer, the consumer can get various benefits when repurchasing a product to his/her taste for product purchase.

Further, in the present invention, a consumer who repurchases a product and thus continuously raises a profit of a seller is provided with an extended validity term of a discount coupon, so that the satisfaction of the consumer can be improved.

Furthermore, in the present invention, even if a discount coupon is used by a third person, the same or similar benefit to that given when an issuer of the discount coupon uses the discount coupon is given to the first issuer of the discount coupon, so that the discount coupon can be efficiently used.

### DESCRIPTION OF DRAWINGS

FIG. 1 illustrates an example of a basic system that realizes a method for directly issuing and using a discount coupon for a product purchased by a consumer himself/herself according to a first exemplary embodiment of the present invention.

### MODES OF THE INVENTION

Hereinafter, exemplary embodiments of the present invention will be described in detail with reference to the accompanying drawings.

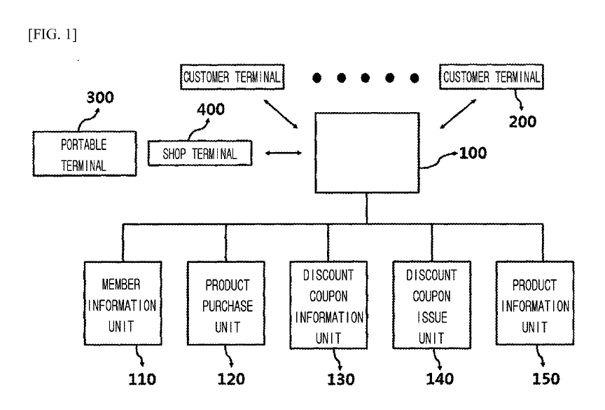

FIG. 1 illustrates an example of a basic system that realizes a method for directly issuing and using a discount coupon for a product purchased by a consumer himself/herself according to a first exemplary embodiment of the present invention.

As illustrated in FIG. 1, a system for realizing a method of the present invention includes a product sales management server 100, a customer terminal 200 interworking with the product sales management server 100, a portable terminal 300, a shop terminal 400, and the like. The management server 100 may include databases such as a member information unit 110, a product purchase unit 120, a discount coupon information unit 130, a discount coupon issue unit 140, and a product information unit 150.

For reference, kinds of the databases described herein shall be construed as including all of those which perform the same functions as the present invention regardless of their names, and may include databases for performing other various functions. The product sales management server 100 shall be construed as performing all of the functions typically realized in connection with basic authentication or Internet transaction.

Further, the product sales management server 100 according to the present invention is linked to various online shopping malls such as an open market through a wired/wireless network.

In the present invention, the member information unit 110 stores a list of members, the purchase unit 120 stores information of a list of products purchased by members, and the discount coupon information unit 130 stores information that enables issuance of a discount coupon having a predetermined discount rate according to a purchase result.

That is, if a consumer as a member purchases a predetermined product, information of the purchased product and the date of purchase are stored in the purchase unit 120, and the discount coupon information unit 130 stores information of a right to issue a discount coupon having a predetermined discount rate corresponding to a purchasing price of a product at each time of purchasing the product.

In the present invention, a member may check a right to issue a discount coupon, select a function button, such as a discount coupon download button, corresponding thereto and then download the discount coupon to his/her portable terminal.

Particularly, in the present invention, a third person may use the discount coupon. In this case, the discount coupon can be transmitted by a portable terminal of the third person or can be transmitted by the portable terminal of the member. Such a transmission method is a general method. Therefore, a detailed description thereof will be omitted herein.

The discount coupon issue unit 140 may store information such as records of issuing discount coupons from the discount coupon information unit 130 by the member and may also store information such as records of entrusting, selling, and transferring a discount coupon issued by the member himself/herself to a third person and using the discount coupon by the third person.

Then, the product information unit 150 stores information of all of the products on sale in an offline shop or online shopping mall (for example, big data relevant to product sales) and finds out each member's taste for product purchase, which enables target marketing of a specific product to specific members.

The customer terminal 200 is a broad concept which encompasses not only a desktop computer and a notebook computer but also the portable terminal 300 such as a smart phone. A member as a consumer may access the management server 100 using his/her customer terminal 200 and register or unregister himself/herself as a member and then, access the discount coupon information unit 130 to issue a discount coupon in a predetermined amount of money. Then, the member may transmit the discount coupon to his/her portable terminal 300 or the portable terminal 300 of his/her friend, family, or coworker so as to be used in a shop or online shopping mall.

In the present invention, the portable terminal 300 to be used in the offline shop is a concept which encompasses mobile phones, such as a smart phone, which can be carried by a consumer.

The shop terminal 400 refers to a device which encompasses a card reader and a bar code or QR code reader capable of reading information of a discount coupon transmitted to the portable terminal 300.

The basic technical concept of the present invention is that when a consumer accesses the management server 100 through the customer terminal 200 and registers himself/herself as a member and then, purchases a predetermined product from an offline shop or the like, the consumer can receive a right to issue a discount coupon having a predetermined discount rate according to a purchase result of the purchased product and issue the discount coupon within a predetermined time period so as to be used by the consumer himself/herself or a third person. In the following, the present invention will be described in detail.

For reference, a product suggested in the present invention is a concept which encompasses all of tangible or intangible products to be sold from offline shops or online shopping malls. The technical concept of the present invention can be used in chain stores such as Dunkin' Donuts, Paris Baguette, Lotteria, and the like, large discount stores, home appliance shops such as Hi-mart, and public transportation vehicles such as buses, subway trains, trains, and the like.

Further, the technical concept of the present invention relates to a method for directly issuing a discount coupon having a predetermined discount rate for each purchased product by a consumer himself/herself when the consumer purchases products. Hereinafter, only a key function performed by the product sales management server 100 will be described. Therefore, in order not to limit the present invention to the databases such as the member information unit 110, the product purchase unit 120, the discount coupon information unit 130, the discount coupon issue unit 140, and the product information unit 150 which can be modified in various ways by those skilled in the art, the present invention will be described assuming that all the functions thereof are naturally performed by the product sales management server 100 according to a program.

Firstly, the method for directly issuing and using a discount coupon for a product purchased by a consumer himself/herself suggested in the present invention is roughly divided into the following three steps:

1. registering member information of the consumer at the member information unit;

2. receiving a right to issue a discount coupon having a predetermined discount rate for a product purchased by the consumer from an offline shop or online shopping mall; and

3. directly issuing and using the discount coupon from the product sales management server by the consumer himself/herself.

Hereinafter, exemplary embodiments of the step 2 and the step 3 as the key technical concepts of the present invention will be described in more detail.

[Right to Issue Discount Coupon]

TABLE 1

| | | | | Number | | | |
|---|---|---|---|---|---|---|---|
| | | | | of Rights | | DC Rate (%) | |
| | | | | to Issue | | for Product | Term of |
| | | | Number | Coupon | Right | per Right to | Validity |
| Product | Date of | Unit | of | per | to | Issue on | of Right |
| Name | Purchase | Price | Purchases | Product | Issue | Repurchase | to Issue |
| A | May 1 | 1,000 | 1 | 1 | 1 | 10% | To May 6 |
| A | May 4 | 1,000 | 2 | 1 | 2 | 10% | To May 9 |
| A | May 9 | 1,000 | 1 | 1 | 1 | 10% | To May |
| | | | | | | | 14 |
| B | May 9 | 2,000 | 1 | 2 | 2 | 5% | To May |
| | | | | | | | 19 |
| B | May 13 | 2,000 | 3 | 2 | 6 | 5% | To May |
| | | | | | | | 23 |
| B | May 18 | 2,000 | 2 | 2 | 4 | 5% | To May |
| | | | | | | | 28 |
| C | May 20 | 3,000 | 1 | 1 | 1 | 7% | To June |
| | | | | | | | 20 |
| D | May 22 | 5,000 | 1 | 1 | 1 | 8% | To June |
| | | | | | | | 22 |

Table 1 lists examples of information to be stored in the product sales management server 100 when a product is purchased according to the method as suggested in the present invention.

According to the present invention, if a consumer as a member purchases a product from an offline shop or online shopping mall, information of a right to issue a predetermined discount coupon for each product is stored in the product sales management server. For reference, the information as listed in Table 1 is provided for each member.

The right to issue a discount coupon refers to a right to issue and use a discount coupon by a consumer who is a member and purchases a predetermined product when the consumer repurchases the predetermined product within a predetermined time period.

For example, as listed in Table 1, when a consumer as a member purchases a product A with a unit price of 1,000 won on May 1, if the number of rights to issue a discount coupon per product A is 1, the right to issue a discount coupon is given one time. In the present invention, in order to promote sales, a term of validity of the right to issue a discount coupon can be set (for example, to May 6). If the discount coupon for the product A is issued within the term of validity and used for repurchase of the product, the consumer as a member can purchase the product A for 900 won.

Therefore, if the consumer uses the issued discount coupon for repurchase of two products A on May 6, the consumer can purchase the two products A for 1,900 won.

Meanwhile, as for the two products A purchased on May 6, two rights to issue a coupon are generated (or given) as listed in Table 1.

[Issuance of Discount Coupon]

The method for issuing a discount coupon according to the present invention will be described.

If a member purchases products, a right to issue a discount coupon for each product is given as listed in Table 1. A term of validity of the right to issue a discount coupon is set. Therefore, the member may issue and use the discount coupon within the term of validity. The reason for this is to promote sales.

For example, the method for issuing a discount coupon is as follows.

A member accesses a product sales management server through a terminal and gets a right to issue a discount coupon for a product purchased on May 1 as listed in Table 1, and a term of validity of the right is set to May 6. The member may issue and use the discount coupon within the term of validity.

The discount coupon may be transmitted to a portable terminal, such as a smart phone, of the member, or may be stored in the member's account in the product sales management server.

The discount coupon transmitted to the portable terminal may be formed of numbers or texts including predetermined information, and may include a bar code or QR code including information of a URL accessible to the server.

The issued discount coupon may include information of the member and information of a product for which the corresponding discount coupon can be used.

The discount coupon transmitted to the portable terminal may be used when a product is purchased from an offline shop. The discount coupon stored in the member's account in the product sales management server may be used at an online shopping mall interworking with the product sales management server.

Since the consumer can get a discount of a predetermined amount of money for additionally purchased products by using the discount coupon, it is possible to lessen the consumer's financial burden.

Meanwhile, regardless of whether or not a discount coupon is used for repurchase of a product, a right to issue a discount coupon is given for each of additionally purchased products by the method as described above.

[Increase in Number of Rights to Issue Discount Coupon]

In the present invention, whenever a product A is purchased, a right to issue a discount coupon is given. However, a member who purchases a predetermined number or more of products A within a predetermined time period may be optionally given an additional right to issue a discount coupon as a kind of a bonus.

[Method for Using Discount Coupon, Which is Issued for Purchase of Product A, for Purchase of Product B]

As described above, if a member purchases a product A from an offline shop or online shopping mall, a right to issue a discount coupon for a product A to be repurchased is given (generated). The member may store a discount coupon issued within a term of validity of the right in his/her portable terminal or his/her account in a product sales management sever and use the discount coupon at the time of payment for repurchase from the offline shop or the online shopping mall interworking with the product sales management sever.

It is preferable to use a discount coupon for repurchase of the same product. However, there may be a member who purchases a product A and wants to use a discount coupon for the product A at the time of purchase of a product B.

Accordingly, in the present invention, the discount coupon issued for purchase of the product A includes information that enables purchase of the product B, and the member can check this information at the time of issuance of the discount coupon from the product sales management server.

As such, the method for using a discount coupon, which is issued for purchase of the product A, for purchase of the product B is as follows.

Purchase of the product A→ . . . →issuance of a discount coupon for the product A→storing the discount coupon in a portable terminal or account→purchase of the product B from an offline shop or online shopping mall→payment with the discount coupon→deduction→payment for the price of the product B after deduction→ . . . →giving a right to issue a discount coupon for the product B

[Giving Right to Issue Discount Coupon Having Predetermined Discount Rate According to Cumulative Number of Product Purchases or Cumulative Purchase Amount]

Meanwhile, in the present invention, if a member purchases a low-profit margin product or low-priced product, a right to issue a discount coupon may not be given.

In the present invention, if the member purchases such a product in a predetermined number or more (or in a predetermined purchase amount or more) for a predetermined time period, the member is determined as a loyal customer. Then, if the cumulative number of product purchases (or cumulative purchase amount) exceeds a predetermined level, a right to issue a discount coupon having a predetermined discount rate may be given, which may be clearly stated in the regulations of the agreement for the service of the present invention and frequently applied.

That is, if a product for which a right to issue a discount coupon is not given is continuously purchased for a predetermined time period, a right to issue a discount coupon may be given as a kind of a bonus. Therefore, the member's loyalty can be increased.

[Free Coupon, Half-Off Coupon]

In the present invention, a right to issue a discount coupon that enables a purchase of a predetermined product for free or for half price, i.e., a discount coupon having a discount rate of 50% or 100% for a predetermined product, may be given for a special offer period or to a VIP member (determined using information such as the number of product purchases, the total purchase amount, and the like).

[Term of Validity of Discount Coupon]

In the present invention, a term of validity of a discount coupon issued by a member is set in order to prevent the member from indiscreetly issuing a discount coupon.

This is because an issued discount coupon can be of benefit to a seller when used at the time of repurchase of a product within a predetermined time period.

Meanwhile, in the present invention, when a specific discount coupon is issued and then used within a term of validity (i.e., when a member uses a discount coupon for repurchase of a product), sales are generated on the seller's part. Therefore, terms of validity of non-exercised rights to issue a discount coupon stored in the product sales management server may be extended by a predetermined time period.

[Stopping Use of Discount Coupon: Expiration of Validity Term of Discount Coupon]

In the present invention, if the term of validity of the issued discount coupon expires, the validity of the discount coupon is automatically extinguished.

[Increase in Validity Term of Discount Coupon]

As described above, if the term of validity of the issued discount coupon expires, the validity of the discount coupon is automatically extinguished, and, thus, the member cannot use the corresponding discount coupon.

According to the present invention, in order to solve such a problem, in the case where a discount coupon issued for purchase of a product A cannot be used (for example, in the case where there is no need to repurchase the product A, in the case where there is no time to purchase the product A, in the case where the product A cannot be repurchased due to a long-term overseas business trip or the like, and the like), when predetermined requirements for reviving this are satisfied, the term of validity of the issued discount coupon may be extended.

For example, in the case where there is no need to repurchase the product A and a product C is purchased without using the discount coupon, a purchase result of the member is created. Thus, the term of validity of the issued discount coupon is extended in return for the purchase result.

Further, in the case of a discount coupon which can be used for repurchase of the product A and can also be used for purchase of a product B and in the case where a discount coupon issued for the product A is used for purchase of the product B, a term of validity may be extended.

Furthermore, in the case where the discount coupon cannot be used for some unavoidable reasons such as a long-term overseas business trip, the member may access the product sales management server and modify a term of validity of the issued discount coupon. However, the number of modifications may be limited.

[Substitutional Use of Discount Coupon by Third Member]

In the present invention, if a member who issues a discount coupon cannot use the discount coupon at the time of repurchase of additional products within a predetermined time period for personal reasons, the validity of the discount coupon is extinguished.

In order to solve this problem, in the present invention, the member who issues the discount coupon may transfer the discount coupon to a third member, and if the third member uses the discount coupon, the member may be given a similar benefit to that given when the member himself/herself uses the discount coupon.

In the present invention, for example, if a member who issues a discount coupon available at the time of repurchase of a product A transmits the issued discount coupon to a portable terminal of a third member and the third member uses the discount coupon for purchase of the product A, the member who issues the discount coupon is given the same benefit as that given when the member himself/herself uses the discount coupon.

For example, the member may be given various benefits such as extension of a term of validity of a right to issue a discount coupon which is given to the member but not yet exercised and a term of validity of an already issued discount coupon, a right to issue a discount coupon for the product A, or the like.

That is, in the present invention, if a discount coupon issued by a member is transmitted to a third member (family, relative, friend, and the like) and used by the third member, the issuer may be given various benefits.

Due to this feature of the present invention, a discount coupon issuer may encourage his/her acquaintances to purchase a product, which results in promotion of product sales.

Meanwhile, if the third member purchases a product using the received discount coupon, the third member is given a right to issue a discount coupon for the product purchased by the third member himself/herself.

[Transfer of Discount Coupon]

The present invention also includes a method for transferring a discount coupon issued by a member to a third member.

According to the present invention, when a discount coupon is transferred, a discount coupon issuer may get a predetermined transfer commission and a third member as a transferee may purchase a product at a lower price by using the discount coupon.

As for the transfer of a discount coupon suggested in the present invention, a system for transferring a discount coupon may be established by, for example, opening a discount coupon exchange market in the product sales management server, thereby providing a corresponding transfer service.

For example, a member who issues a discount coupon having a discount rate of 10% for a 1000-won product A may post the discount coupon on the discount coupon exchange market provided by the product sales management server or transmit and transfer the discount coupon to a portable terminal of a third member through a wireless network from a portable terminal equipped with a function that enables a downloaded discount coupon to be transferred to the third member. As such, a discount coupon may be transferred in various ways.

A discount coupon basically includes information of a first issuer. Thus, if the discount coupon is transferred to a third member and the third member purchases a product using the discount coupon, a part of the sale money for the corresponding product may be provided to the first issuer.

That is, if the third member uses the transferred discount coupon, the product sales management server may accumulate a part of the sale money for the product in the form of electronic points, cash, or the like in an account of the first issuer.

All of these processes are performed in the product sales management server.

[Change in Discount Rate on Transfer of Discount Coupon]

When a discount coupon issuer transfers a discount coupon to a third member, if a discount rate of the discount coupon is, for example, 10%, the discount rate of 10% may be applied to the third member when purchasing a product. However, the present invention suggests that the third member may use the transferred discount coupon applied with a discount rate slightly lower than an initial discount rate.

That is, when a discount coupon is transferred, the product sales management server may slightly lower a discount rate according to a kind of the discount coupon (whether or not a product for which a discount coupon is issued is expensive) so as to be used by the third member.

Even in this case, the third member does not make a loss.

This is because even if the third member uses a discount coupon of which a discount rate is changed from 10% to 5% at the time of transfer, the third member is applied with a discount rate of 5% when purchasing a predetermined product.

All of these processes are automatically performed in the product sales management server in case of transfer.

Meanwhile, a term of validity of a discount coupon transferred according to the present invention can be set.

[Setting of Automatic Issuance and Use of Discount Coupon]

As described above, in the present invention, if a member purchases a product from an offline shop or online shopping mall, a right to issue a discount coupon for the product is generated, and when the member repurchases the product thereafter, the member may issue the discount coupon to purchase the product at a lower price.

However, a discount coupon needs to be issued by each member. Therefore, in the present invention, an optional function of “setting of automatic issuance and use of discount coupon” is provided to increase the convenience of the member as a consumer.

In this case, the following methods may be performed.

Firstly, if a member shows his/her membership card when purchasing a product from an offline shop, a shop terminal accesses the product sales management server. If there is a right to issue a discount coupon, the price is automatically settled.

Secondly, if a portable terminal of a member accesses the product sales management server to select a function of automatic issuing a discount coupon provided by the product sales management server, the product sales management server searches for a right to issue a discount coupon of the member, the number of valid rights, and a valid discount rate. If there is a right to issue a discount coupon related to a product to be purchased, the discount coupon is automatically issued and used.

In this case, the member may easily use his/her discount coupon without a need to remember information of each of his/her rights to issue a discount coupon and other discount coupons.

As described above, the method for issuing a predetermined discount coupon for each purchased product by a member himself/herself so as to be used for additional purchase according to the present invention can be generally summarized as below.

1. The present invention starts from registration of a consumer at a product sales management server.

The consumer may become a member by accessing the product sales management server through a terminal such as a smart phone or a computer and registering himself as a member according to a conventional registration process.

Otherwise, in an offline shop, the consumer may register himself/herself as a member at the product sales management server by issuing a membership card.

2. After the registration as a member, if the consumer purchases a product, the following operations are carried out.

For reference, the product may be purchased from the offline shop or an online shopping mall interworking with the product sales management server.

(1) Whenever a product is purchased, a right to issue a discount coupon having a predetermined discount rate for the corresponding product is stored in the product sales management server.

(2) The member may issue a discount coupon having the predetermined discount rate by using the right to issue a discount coupon stored in the product sales management server.

The issued discount coupon can be stored in the member's account in the product sales management server or transmitted to a portable terminal of the member.

The discount coupon stored in the member's account in the product sales management server may be used at the online shopping mall, and the like.

The discount coupon transmitted to the portable terminal may be read by a shop terminal of the offline shop and used at the offline shop.

(3) In the present invention, whenever a product is purchased, a right to issue a discount coupon with a determined term of validity is given. The term of validity may be extended according to a repurchase result of the member.

(4) A discount coupon of the present invention can be used by a third person. For example, a method for transmitting an issued discount coupon to a portable terminal of the third person may be employed.

In this case, if the third person uses the received discount coupon when purchasing a product, a first discount coupon issuer may be given various benefits according to a usage result thereof.

(5) Further, in the present invention, the member or the third person may be given various additional benefits regarding a validity term of a right to issue a discount coupon and an issued discount coupon according to a repurchase result.

If the above-described method related to the discount coupon is used, there are advantages as follows.

1. Since a consumer is given a right to issue a discount coupon for each product purchased by the consumer, when the consumer can get various benefits when repurchasing a product to his/her taste for product purchase.

2. In the present invention, a consumer who repurchases a product and thus continuously raises a profit of a seller is provided with an extended validity term of a discount coupon, so that the satisfaction of the consumer can be improved.

3. Further, in the present invention, even if a discount coupon is used by a third person, the same or similar benefit to that given when an issuer of the discount coupon uses the discount coupon is given to the first issuer of the discount coupon, so that the discount coupon can be efficiently used.

As for the above-described technical concept of the present invention, i.e., the invention relating to a method for directly issuing and using a discount coupon and getting various benefits, various modifications and substitutions obvious to those skilled in the art within the scope of the accompanying claims will be construed as being included in the protective scope of the present invention.

1. A method for directly issuing a predetermined discount coupon for each purchased product by a member himself/herself when the member purchases a product from an offline shop or online shopping mall with a system including a terminal into which a product purchase status is input and a product sales management server interworking with the terminal through a wired/wireless network so as to be used for further purchase of a product, the method comprising: (a) transmitting purchase information of at least one product purchased by the member to the product sales management server through the terminal; (b) generating at least one right to issue a discount coupon having a predetermined discount rate for each product purchased by the member and storing the right in the member's account in the product sales management server; (c) accessing the product sales management server through a portable terminal of the member and issuing a discount coupon having a predetermined discount rate using the at least one right to issue a discount coupon stored in the product sales management server; and (d) wirelessly transmitting the issued discount coupon from the product sales management server to the portable terminal of the member,
wherein a term of validity is individually set for each of the at least one right to issue a discount coupon stored in the product sales management server, the discount coupon includes information of the member who issues the discount coupon and information of a product for which the discount coupon can be used, if the discount coupon issued by exercising at least any one of the at least one right to issue a discount coupon within the term of validity is transmitted to the portable terminal and then, the discount coupon is used at the time of payment for repurchase of a product through the terminal, a term of validity of at least one non-exercised right to issue a discount coupon is additionally extended by a predetermined time period or a term of validity of an already issued discount coupon is additionally extended by a predetermined time period.

2. The method of claim 1, further comprising:
(e) using the discount coupon, which is wirelessly transmitted to the portable terminal of the member and then retransmitted to a portable terminal of a third member, by the third member,
wherein if the third member purchases a predetermined product using the discount coupon, the term of validity of at least one non-exercised right of the member to issue a discount coupon is additionally extended by a predetermined time period with reference to the information of the member included in the discount coupon.
